(19) United States
(12) Patent Application Publication
(10) Pub. No.: US 2008/0006689 A1
(43) Pub. Date: Jan. 10, 2008

(54) Electronic business card

(76) Inventor: Shevin Conway, Secaucus, NJ (US)

Correspondence Address: Shevin Conway, 10 Riverview Court, Secaucus, NJ, 07094, US

(21) Appl. No.: 11/481,998

(22) Filed: Jul. 6, 2006

(51) Int. Cl. G06K 5/00; G06K 19/06

(52) U.S. Cl. 235/380; 235/492

(57) ABSTRACT

Recited and explanation in EBC Provisional.

### CROSS REFERENCE TO RELATED APPLICATION

The instant application claims priority to U.S. Provisional Patent Application No. 60/696,566, filed Jul. 5, 2005, which is incorporated by reference in its entity herein (“EBC Provisional”).

### FIELD OF THE INVENTION

Recited and explanation in EBC Provisional.

### BACKGROUND OF THE INVENTION

Recited and explanation in EBC Provisional.

### SUMMARY OF INVENTION

Recited and explanation in EBC Provisional.

### BRIEF DESCRIPTION OF THE DRAWINGS

Recited and explanation in EBC Provisional.

### DESCRIPTION OF A PRESENTLY PREFERRED EMBODIMENT

Recited and explanation in EBC Provisional.

We claim:

1. A device for storing data with the intent of substituting traditional business and/or identification cards, said device comprising:
a display, said display capable of rendering a plurality of information comprising, corporate information, personal information, identification information, and other information;
a memory, said memory allowing a capture and a store of said plurality of information; and
a transferring component, said transferring component providing transmission of at least a portion of said plurality of information to other devices.
